(19) United States
(12) Patent Application Publication
(10) Pub. No.: US 2010/0222080 A1
(43) Pub. Date: Sep. 2, 2010

(54) CONTEXT AWARE WIRELESS INFORMATION SYSTEM AND METHOD

(76) Inventors: Iacopo Carreras, Sopramonte (IT); Daniele Miorandi, Gardolo di Trento (IT); David Tacconi, Trento (IT); Francesco De Pellegrini, Trento (IT)

Correspondence Address: SQUIRE SANDERS & DEMPSEY LLP, 1 E. WASHINGTON ST., SUITE 2700, PHOENIX, AZ, 85004, US

(21) Appl. No.: 12/681,770

(22) PCT Filed: Oct. 5, 2007
(86) PCT No.: PCT/IB07/54065

§ 371 Date: Apr. 5, 2010

(51) Int. Cl. H04W 64/00

(52) U.S. Cl. 455/456.3

(57) ABSTRACT

The invention relates to a system and method for providing context-aware services in pervasive computing environments. Specifically it targets environments where a plurality of intermittently connected portable computing devices interact with each other and possibly a plurality of embedded computing devices, that can be fixed in a certain environment. Said portable computing devices communicate with each other via some forms of proximity wireless communications when getting within mutual communication range. Said embedded devices can communicate with said portable devices via a wireless communication interface when getting within mutual communication range. The method proposed is particularly suited for transparent dissemination (i.e., requiring no explicit user intervention) of contextual information, in the form of data which relates to the context the user is in. Some examples of specific forms of contextual information include, but are not limited to: location information, time information, user activity information, information on locally available resources.

### BACKGROUND

The invention pertains to improved systems and methods for supporting the provision of context-aware services in pervasive computing environments; specifically it relates to a scenario in which a plurality of intermittently connected portable computing devices is present, possibly together with a plurality of embedded computing devices.

According to the invention, the task mentioned above is solved by a method showing the characteristics of patent claim 1.

Moreover, embedded computing devices may present minimal supported features in terms of computing and communications, and are meant to provide portable devices (with which the users interface) with information which can be exploited to identify the context where the user is in. Said embedded computing devices act as sources of information and do not necessarily include a user interface. Said embedded devices may preferably include a sensing board for gathering contextual data. Some examples of said embedded devices include, but are not limited to, RFIDs, standard sensor network devices, devices exposing/broadcasting local information etc. Portable computing devices may present a set of extended features in terms of computing and communications; they also necessarily include a user interface. They are meant to interface with the end-users and may be inherently mobile. Some examples of portable computing devices include, but are not limited to, smartphones, personal digital assistants, multimedia computers, laptops etc.

Said embedded devices can communicate with said portable devices via some forms of proximity wireless communications when getting within mutual communication range. Said portable devices can communicate with each other via some form of wireless proximity communications when getting within mutual communication range. Connectivity among portable devices may vary over time as a consequence of a plurality of factors, including, e.g., users' mobility and radio channel conditions.

The method proposed is particularly suited for dissemination of contextual information, in the form of data which relate to the context in which the user is present. Some examples of specific forms of contextual information include, but are not limited to, location information, time information, user activity information, information on locally available resources etc.

Data may be transferred among portable computing devices and embedded computing devices exploiting contact opportunities, where a contact is defined as the ability of at least two devices to setup a transmission channel (through proximity wireless communication means) and exchange messages on such transmission channel. The present invention is particularly suited to scenarios characterized by intermittently connected and often partitioned networks, in which contacts are rare events, which may take place at unpredictable time instants. The present invention is able to leverage such opportunities for localized exchange of data (in an “opportunistic” fashion) to enhance the quality of the service offered to the end-user. Context information is transmitted via wireless communications to portable computing devices from said embedded computing devices or other portable devices.

Each portable computing device presents one or multiple profiles, associated to its user(s). The user profile contains personal information about the user and may include, e.g., a description of its preferences and interests. The method of present invention can use context information, appropriately filtered on the basis of the user profile, to change the behavior of one or many applications running on the device. The information contained in the user profile is also used to control the forwarding of data messages from other personal computing devices upon a contact between the two devices.

A main advantage of the present invention relates to the fact that the proposed system is able to exploit (in an “opportunistic” fashion) the possible presence of nearby devices equipped with some form of proximity wireless communication interface to provide some forms of exchange of data able to enhance the service behavior.

One of the problems in such scenarios, solved by the present invention, is the possibly short duration of contacts.

Conventional methods are based on a three phases approach:
1. Discovery of all neighbor devices
2. Discovery of running services on each of the neighbor devices
3. Exchange of data with the devices running the same service.

This kind of approach is the one used in [Personal profile sharing and management for short-range wireless terminals. U.S. Pat. No. 7,249,182] and [(WO/2007/081524) MEDIA DATA EXCHANGE, TRANSFER OR DELIVERY FOR PORTABLE ELECTRONIC DEVICES].

Such method fails in the presence of short contacts duration and of a large number of co-located devices (which happens, e.g., when people walking on a crowded street in opposite directions with a Bluetooth-enabled smartphone meet). The failure is due to the fact that task (1) may end up taking a long time and the same problem applies to task (2) as well.

The joint device and service discovery method of present invention (200,300), which sets up a communication link with one neighbor at one time only, is able to overcome such limitations.

The proposed system is able to work in the absence of continuous backhaul connectivity to a remote server. The conventional approaches, in which a client establishes a connection with a remote server, fail to work in intermittently connected wireless networks where interactions among peer devices take place sporadically. An example of such an approach based on continuous connectivity can be found in [Personalized information retrieval using user-defined profile. U.S. Pat. No. 5,761,662]. A main limitation of this approach is the lack of a possibility of extending the service to a scenario in which a plurality of mobile devices communicates intermittently via proximity wireless communications.

This limitation is solved by the proposed system which is able to work in a system where devices and users are not continuously connected. Such a solution is also not encompassed in [Method and system for distributing contents to a plurality of users, US-20070183354].

On the contrary the present invention is able to deal with such scenarios thanks to the opportunistic communication unit (108) which is in charge of enabling the setup of communication channels with neighboring devices running the same service, whenever present.

It is also important to stress that the proposed system does not require IP connectivity for exchanging data. IP, indeed, does not work well in intermittently connected networks, in which it is difficult (if not even impossible) to ensure consistency of IP routing tables and uniqueness of IP addresses, due to possibly frequent disconnections. Such an approach is the one presented as a preferred embodiment in [Peer-to-peer network and user information discovery and sharing for mobile users and devices US2006098588)]. Our invention, on the other hand, may well work on top of layer-2 connectivity only, without requiring the use of IP addresses. As an example, the proposed methods can be readily implemented on top of RFCOMM for Bluetooth-enabled smartphones; in such case the opportunistic communication unit (108) will interface with other portable devices through RFCOMM links. Similarly, the proposed system can be readily implemented employing protocols working on top of RFCOMM links, including OBEX and BNEP or using BNEP for a wifi based communication link or more generally layer 2 communication protocols implemented for wifi, webree or zigbee technologies.

Moreover, the proposed system does not rely on the user profile only for generating a data request; the interest list is instead determined on the joint basis of the user profile (maintained by the profile manager, 102) and of the running service (which is accessed through the service container, 103). This is a key feature in pervasive computing environments, in which the high dynamism of the system and the limited resources require the running service to play a fundamental role in determining the content to be requested. As an example, a service running on very limited resources may limit the interests listed in the user's profile in order to get only the content with the highest impact on the user-perceived quality of experience. This situation can be easily accommodated by our invention, in which the interest manager (105) may decide to limit the list of exposed interests. Conventional approaches rely instead only on the use of user profile [Personalized information retrieval using user-defined profile. U.S. Pat. No. 5,761,662.

### BRIEF DESCRIPTION OF THE DRAWINGS

FIG. 1 System components

FIG. 2 Message exchange during a successful discovery and exchange process

FIG. 3 State transition during the discovery and exchange process

FIG. 4 Alternation between states of two devices within the communication range

FIG. 5 System components interaction flow, when generating the user interests

FIG. 6 System components interaction flow when retrieving data, starting from user interests.

FIG. 7 Block diagram of the proposed method

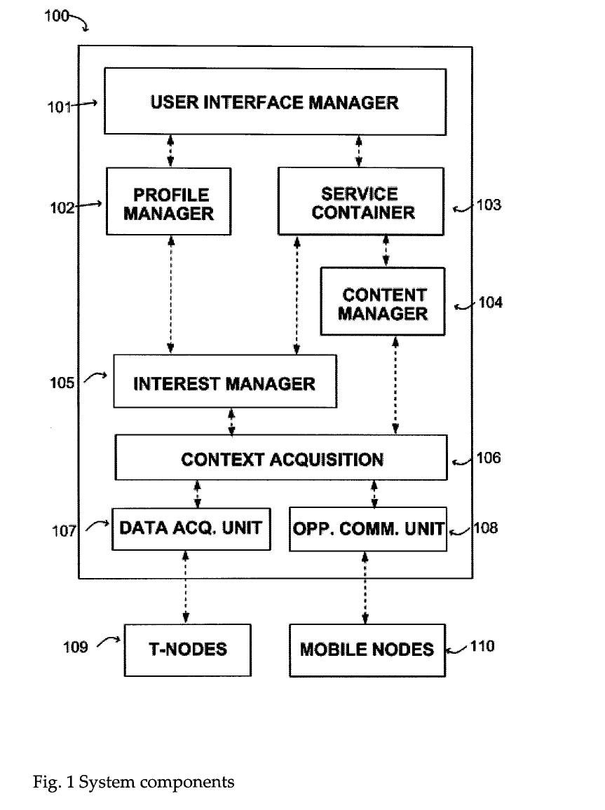

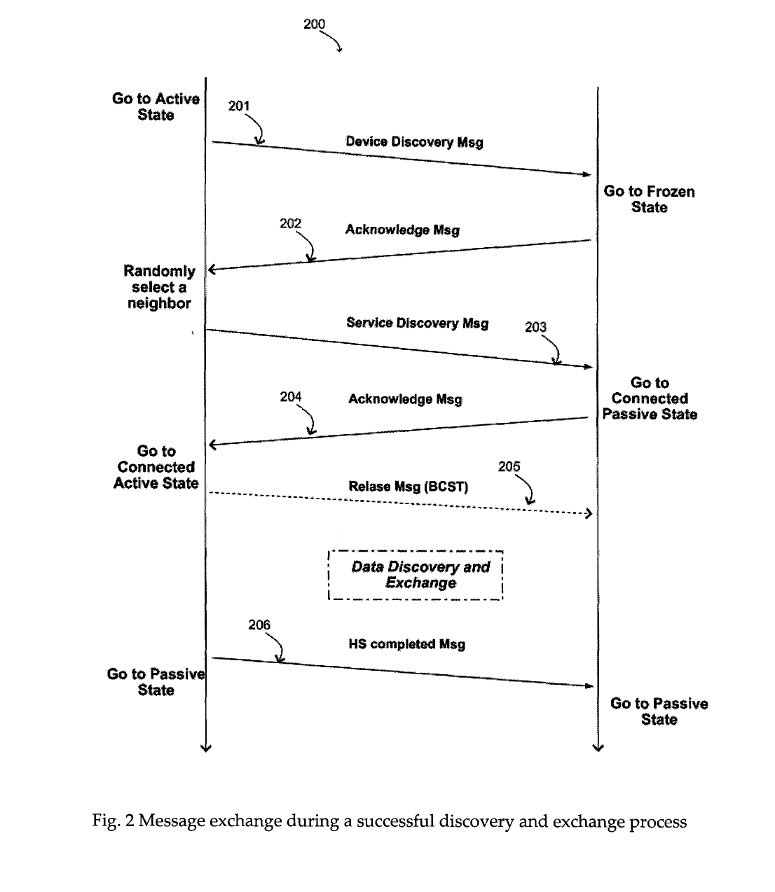

### DETAILED DESCRIPTION OF THE INVENTION

Three use cases are presented to better frame the problem and highlight the advantages of the proposed invention.

The first one relates to mobile peer-to-peer applications, in which mobile devices exchange information about:

(i) the profile of the user currently active

(ii) the data available in the shared data space.

A match between profile and data triggers the execution of a transfer of information from the device having the data and the one potentially interested in it.

The second one relates to mobile advertising information, in which the proposed system can be used to (i) gather and diffuse advertisement from local shops (ii) present the user with the advertisement relative to products matching her/his needs and search criteria.

The third one relates to an enhanced reduced keyboard disambiguation systems (i.e., enhanced T-9). In this case, the system and methods proposed are used for exchanging dictionary words among users having common entries in the respective profiles. This comes from the observation that (i) users sharing some common interests tend to use specialized terms which are usually not included in general-purpose dictionaries, as the ones commonly delivered with T-9 (as an example, we may think of the terms “carabiner”, “grigri” and “jumars”, commonly used by climbers but not used outside such domain) (ii) some words are used in restricted geographical areas only (e.g., dialects and some forms of slang or in general terms to a geographically customized dictionary).

An embodiment of the proposed invention (100) would include computing means for carrying out the following operations:
Profile Manager (102): the profile manager handles the creation/update/deletion of the user profile. Such profile is explicitly created by the user, and dynamically updated on the basis of users daily activities. Such profile information is permanently stored in the device's memory, and read at system bootstrap phase.
Service Container (103): the service container is the environment where context-aware services are executed. Such Container provides seamless access to resources such as content storage, opportunistic data retrieval, profile information, etc. In addition, the service container provides service deployment, update and deprecation functionalities.
Data Acquisition Unit (107): this is an optional communication unit in charge of gathering contextual data from nearby embedded devices with sensing capabilities (109). Such unit periodically searches for available data sources, and takes care of all the necessary communication steps that are needed for reading sensor information. This unit communicates with the context acquisition unit for deciding which contextual data is relevant to the user.
Opportunistic Communication Unit (OCU) (108): the opportunistic communication unit transparently manages data exchanges among portable devices encountering on the move (110). This unit (108) handles any operation needed for setting up and tearing down the communication with other portable devices, in a transparent way for the user (including, e.g., handling the access to multiple radio interfaces).
Context Acquisition (106): the context acquisition unit stores/update/removes data according to user preferences and service requirements. This component represents the interface between the communication layers and the intermediate layers, where information is processed and stored. In particular, this unit executes all the policies that define which information will be stored or diffused, and which information will be discarded.
Interest Manager (IM) (105): the interest manager unit merges the user profile and the requirements originating from the hosted services into interests, which are a description of the data requested by the user.
Content Manager (104): this component manages the system's permanent storage. In particular, this unit stores any data item considered as relevant by the Interest Manager. It is accessed by the Interest manager for storing any incoming data, and by the service container for augmenting context-aware services.

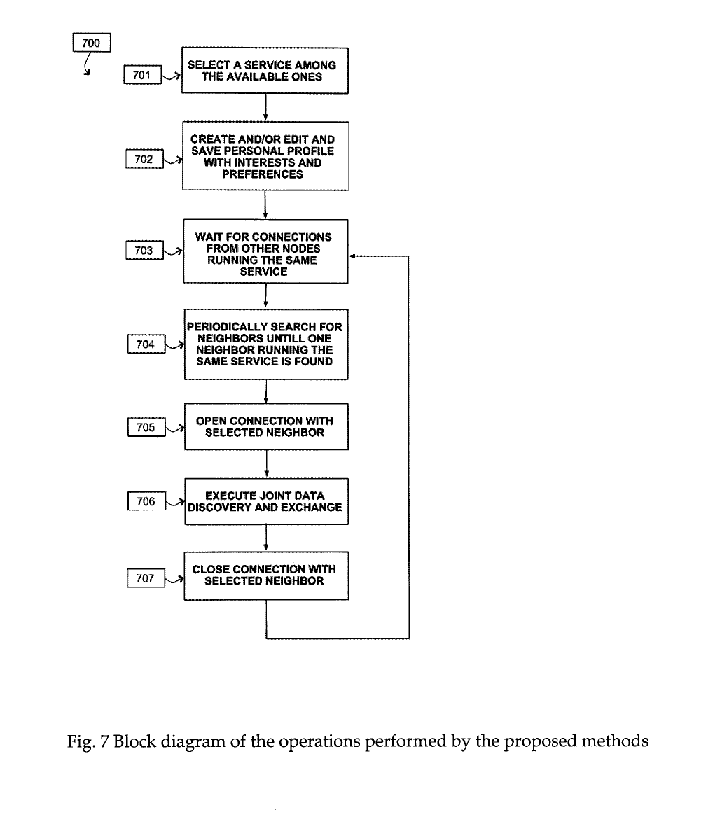

The relation among the various components in an operational phase, is graphically depicted in FIG. 7.

Device and Service Discovery

One aspect of the invention pertains to discovery of nearby devices and of the services running on said devices (200, 300, 400).

The goal of the device and service discovery processes is to find one nearby device running the same service and with which data discovery and exchange can be performed. In the proposed invention, each device can be in either one of two states: discoverable (passive state, 303) or discovering (active state, 302, 401, 403, 406)). Nodes are in passive state most of the time (402, 405, 407, 410); the transition to the active state is controlled by a thread which periodically triggers the device discovery process. In order to discover nearby devices, each said portable device in active state broadcasts at least one beacon message (201), signaling its presence. All nearby devices in passive state listening on the same wireless channel acknowledge the beacon reception (202), signaling their presence. A device receiving a beacon message freezes its internal state (304) to the passive mode until it gets released by the device which sent the beacon message. In the case of discovering of at least one said devices, the device in the active state adds the MAC address of said device in its internally maintained neighbor list. The active device (i) randomly chooses one of its neighbor (ii) polls such neighbor by sending a service discovery message (203). Steps (i) and (ii) are repeated until either a device running the same service is found (204) or all neighbors are polled without success. In both cases, a message is broadcasted to release all discovered devices apart from the one running the same service (205), whenever present. A device in passive state, which receives such release message, goes back to the normal operating state (303). If a device running the same service is found, devices move to connected active state (301, 404)) and connected passive state (305, 409), respectively. Then, data discovery and exchange are performed with said device. Data discovery and exchange is therefore performed with one single device at time.

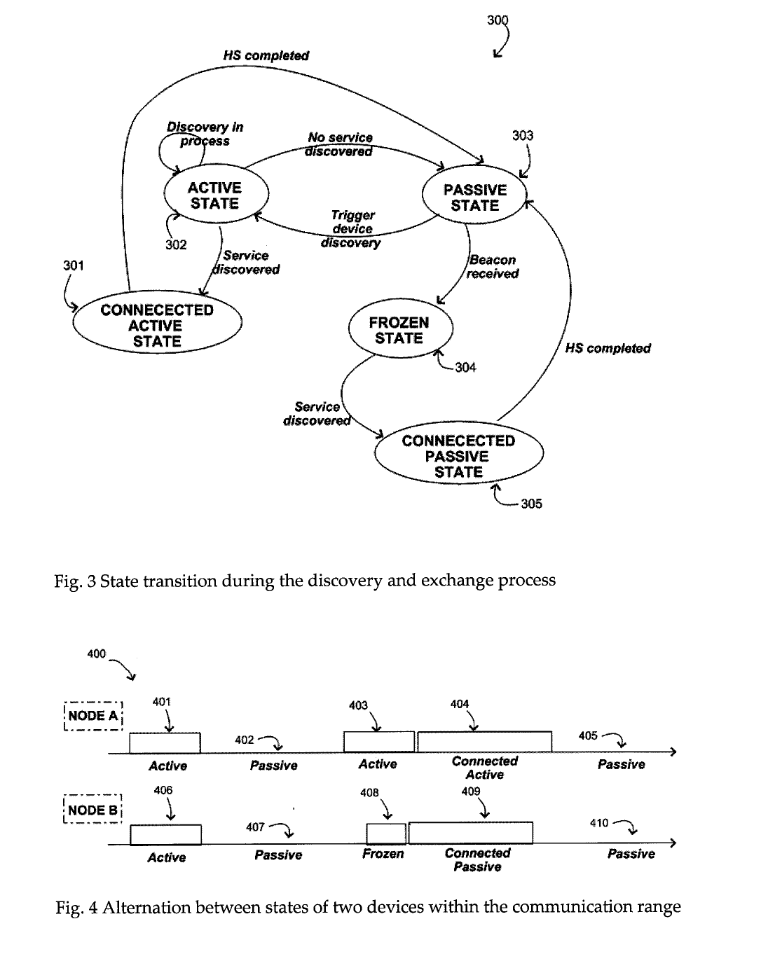

The state transitions incurred by any device in the discovery and exchange processes are depicted in FIG. 3 (300). Such representation, in the form of a finite state machine, is meant to provide a graphical explanation of the process described in details above.

In FIG. 4 (400), further, a representation of the state of two devices within communication range versus time is represented. The first device and service discovery process fails in that both devices are in the active state; the second attempt is successful and lead to data discovery and exchange.

The aforementioned device and service discovery can be embodied in any device supporting some form of proximity wireless communications. Some examples of specific communication technologies include, but are not limited to, Bluetooth, the IEEE 802.15 family of standards, the IEEE 802.11 family of standards, WiBree.

Joint Data Discovery and Exchange

One aspect of the invention pertains to discovery and exchange of data among nearby devices.

According to the device and service discovery procedure outlined above, data discovery and exchange is therefore performed with one single device at a time. The device in the connected active state (301) sends a unicast message to the device in the connected passive state (305), describing its interest. Such interest can be expressed in various ways, depending on the particular embodiment. Some examples of specific forms of methods for expressing interests include, but are not limited to, a list of <attribute,value> pairs, where attribute indicates the label of the specific metadata field, and value its current value, a tree structure expressed in XML format, a list of triples in the form of subject-predicate-object expressions (such as in RDF). Upon reception of said message, the device in the connected passive state inquiries its local repository to see if any of the data contained matches said description. The data presenting a positive match (if any) is grouped into a single message. Said message is enriched with a description of the interests of the device in the connected passive state and sent to the device in the connected active state (301). The metadata matching procedure is repeated at the device in the connected active state (301), which sends then a message to the other device with the relevant data, if any. Then, the device in the connected active state (301) sends a completed handshake message (206) to the device in the connected passive state (305) and moves back to the passive state (303, 405). Upon reception of the completed handshake message, the device in the connected passive state (305) moves back to the passive state (303, 410).

The described joint data discovery and exchange method can be implemented on top of a layer 2, such as the RFCOMM of the Bluetooth stack or IEEE 802.15.4, or wifi or on top of a layer 4, as an UDP socket over any proximity wireless connection. This means that the implementation of the platform can be easily done on every mobile device with a wireless interface, where specific API are available (as for instance the JSR82 API for accessing Bluetooth functionalities in J2ME enabled mobile devices).

FIG. 4 describes the overall exchange of messages during a successful discovery and exchange process.

The described operations for joint data discovery and exchange require the system to:

(1) build the user interests starting from the user profile and hosted services

(2) retrieve any data matching some specific interests.

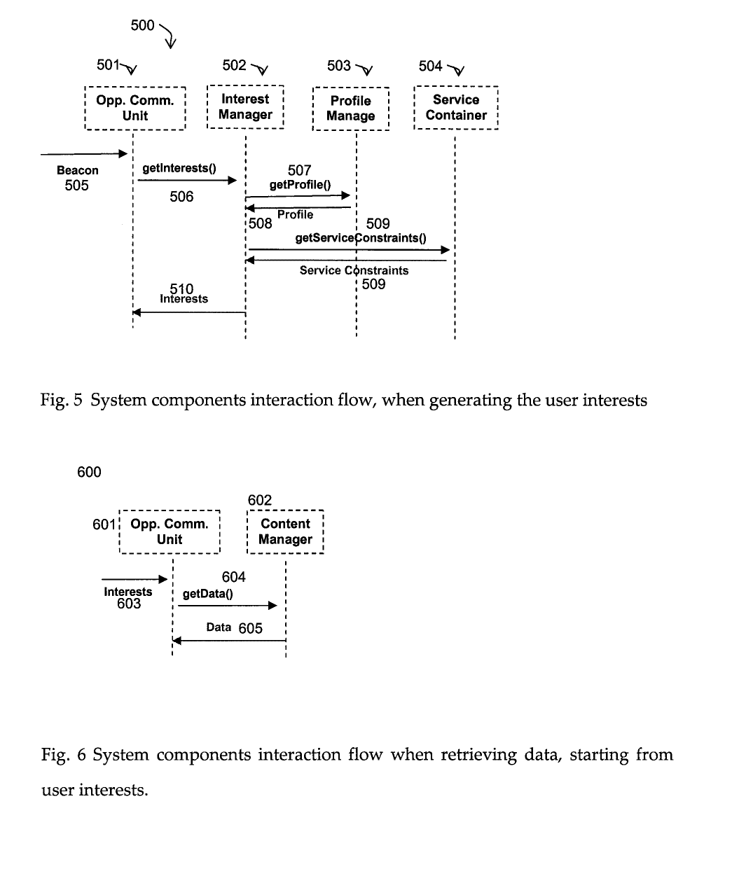

The former functionality is briefly depicted in FIG. 5 (500) together with the internal system components involved in the process. The process is described as follows.

Upon reception of a beacon message (505) from the Opportunistic Communication Unit (501), a getInterest( ) (506) request is invoked to the Interest Manager (502). The Interest Manager answers with the User Interests (510), which are generated taking into account the User Profile (508), which is retrieved from the Profile Manager (503) (getProfile( ) method invocation (507)), and the service requirements, which are obtained from the Service Container (504) (getServiceConstaints( ) method invocation (509)).

The second functionality in reported in FIG. 6.

Interests (603) are received from the Opportunstic Communication Unit (601), which invokes a getData( ) (604) call to the Content Manager (602). The Content Manager (602) returns any stored data (605) matching the interests received from the other device. The Opportunistic Communication Unit (601) is then in charge of sending the retrieved data to the encountered device.

FIG. 7 (700) shows a block diagram representation of the relation among the various components of the proposed method. First, the user is required to select a service among all those offered by the portable device (701). Once the service is selected, the user is required to create and/or edit the personal profile according to her/his interests and preferences (702). Once the profile is saved the application starts waiting for incoming connections (703) and periodically searches for close-by neighbors running the same service (704). Once one neighbor running the same service is found, the application stops searching for other neighbors and opens a connection with the selected neighbor (705). At this point, the joint data discovery and exchange is executed (706) until all data matching the devices' interests are exchanged. Finally the connection is closed (707) and the application waits again for incoming connections from devices running the same service. It is worth remarking that, in this invention, all processes of selecting one neighbor, connecting to it, performing jointly data discovery and exchanging and closing the connection are transparent to the user. Indeed, the user is required only to select a service and create or edit her/his personal profile and save it in her/his portable computing device.

All the methods mentioned in the description can also obviously be implemented in software running on the computing means of the portable or embedded devices.

1. A method for providing context information between at least two portable devices, each comprising at least a user profile and information related to the environment where said portable devices are located,
characterized in that:
said context information is obtained by correlating information related to said user profile of at least one of said portable devices and information related to the environment where said portable devices are located, said information related to the environment being present on at least one of said portable devices,
and in that:
one of devices in the active state contacts a device in passive state, giving a description information about said user profile or said information related to the environment
said device in passive state enquires its local repository to check the presence of data matching said description information
if said data matching said description information are present, then a detailed description of the information present on the passive device is sent to the active device and data are exchanged between the devices

2. The method of claim 1 wherein said information related to user profile or to the environment are expressed in the form of subject-predicate-object as in RDF or pars <attribute,value>

3. The method of claim 2 wherein the portable devices communicate employing a short range communication system and the exchange of information is realized by employing layer 2 protocols.

4. The method of claim 3 wherein the short range communication system is Bluetooth and the exchange of information is realized by employing layer 2 protocols.

5. The method of claims 3-4 wherein the exchange of information is realized by employing the RFCOMM or BNEP protocols.

6. The method of claim 3 wherein the portable devices communicate via wifi and the exchange of information is realized by employing the OBEX protocol.

7. The method of claims 3-6 where the information exchanged relates to an update of the T9 dictionary, said update comprising additional words matching the interest of the user profile and the characteristics of the environment where said embedded devices are set

8. The method of claim 3-6 wherein the information exchange relates to advertisement matching the user profile

9. A system for providing context information between at least two portable devices each comprising at lest a user profile and information related to the environment where said portable devices are located, characterized in that said portable devices comprise:
computing means for obtaining context information by carrying out a correlation of information related to said user profile of at least one of said portable devices and information related to the environment where said portable devices are located, said information related to the environment being present on at least one of said portable devices,
computing means operative connected to wireless communication means and user input means so that the device in the active state contacts a device in passive state, giving a description information about said user profile or said information related to the environment
computing means for executing enquires on its local repository to check the presence of data matching said description information
computing means connected to said communication means for sending a detailed description of the information present on the passive device to the active device if said data matching said description information are present.

10. The system of claim 9 wherein said computing means and said communication means of said portable devices are configured to support BNEP or OBEX protocols

11. The system of claim 9 wherein said computing means of said portable devices are configured to update the T9 dictionary.

12. The system of claim 9 wherein said computing means of said portable devices are configured to exchange advertisements

13. A computer readable medium having computer executable instructions therein, which, when executed by a computer performs the method of claims 1-6.
